(19) United States
(12) Patent Application Publication
(10) Pub. No.: US 2008/0046491 A1
(43) Pub. Date: Feb. 21, 2008

(54) CONFIGURABLE UNIT CONVERSION SYSTEMS AND METHODS THEREOF

(75) Inventors: Arun Gupta, Faridabad (IN); Sukrit Kumar Mehra, Meerut (IN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PIXTEL MEDIA TECHNOLOGY (P) LTD., Noida (U.P.) (IN)

(21) Appl. No.: 11/750,354

(22) Filed: May 18, 2007

(30) Foreign Application Priority Data
Jun. 27, 2006 (IN) 1501/DEL/2006

(51) Int. Cl. G06F 3/00; H04Q 1/50

(52) U.S. Cl. 708/164; 455/412.1; 455/414.1; 708/160; 708/206

(57) ABSTRACT

A unit conversion system configuration method includes the following steps. The unit conversion system includes a unit converter converting a unit to another unit utilizing a repository of unit conversion information in the system. The system receives new conversion information in a message transferred thereto. The new conversion information is added to the repository to provide the unit converter with a new unit conversion function based on the new conversion information without updating the unit converter.

### CROSS REFERENCE TO RELATED APPLICATIONS

This application claims the benefit of Indian Provisional Application No. 1501/DEL/2006, filed 2006.6.27.

### BACKGROUND OF THE INVENTION

1. Field of the Invention

The invention relates to computer techniques, and more particularly to unit converters.

2. Description of the Related Art

Unit conversion from one measurement system to another is an occasional demand. The unit desired to be converted to or from may vary by person and occasions. One person may want to convert a metric unit to an American unit, and another person may want to convert an exotic unit to his own local unit. Current technologies, such as calculators and others, however, only allow conversion of a fixed number of units. That is, current converters are designed to convert specific units. A device cannot convert a unit which is not part of its application design. It is difficult to predict in the device design stage what unit conversion functions are necessary for respective users and it may be difficult to include all known measurement systems in one device.

Additionally, as exchange rates between currencies change daily, embedding a currency conversion logic in a device with static currency exchange information has no utility.

### BRIEF SUMMARY OF THE INVENTION

An exemplary embodiment of a configurable unit conversion system comprises a memory, a unit converter, a communication module, and an update module. The memory comprises a repository of unit conversion information. The unit converter converts a unit to another unit utilizing unit conversion information in the repository. The communication module receives a message transferred to the system. The update module extracts new conversion information from the received message and integrates the new conversion information to the repository to enable automatic utilization by the unit converter of the new conversion information for unit conversion.

An exemplary embodiment of a unit conversion system configuration method comprises the following steps. The unit conversion system comprises a unit converter converting a unit to another unit utilizing a repository of unit conversion information in the system. The system receives a message. New conversion information is extracted from the received message and integrated to the repository to enable automatic utilization of the new conversion information by the unit converter for unit conversion.

An exemplary embodiment of a unit conversion system configuration method comprises the following steps. The unit conversion system comprises a unit converter converting a unit to another unit utilizing a repository of unit conversion information in the system. The system receives new conversion information in a message transferred thereto. The new conversion information is integrated to the repository to provide the unit converter with a new unit conversion function based on the new conversion information without updating the unit converter.

An exemplary embodiment of a unit conversion system configuration method comprises the following steps. The unit conversion system comprises a unit converter converting a unit to another unit utilizing a repository of unit conversion information in the system. The system receives a message with new conversion information. The new conversion information is integrated to the repository. The unit converter automatically retrieves the new conversion information and executes unit conversion utilizing the new conversion information.

An exemplary embodiment of a unit conversion system configuration method comprises the following steps. The unit conversion system comprises a unit converter converting a unit to another unit. A value of a source unit to be converted to a target unit is received. The source unit and the target unit are utilized to search for corresponding conversion information in the system. When the corresponding conversion information is unavailable in the system, a request is automatically sent for the corresponding conversion information of the source unit and the target unit.

An exemplary embodiment of a unit conversion system configuration method comprises the following steps. The unit conversion system comprises a unit converter converting a unit to another unit utilizing a repository of unit conversion information in the system. New conversion information is stored in a nonvolatile memory of the system and imported therefrom to the repository, thus to provide the unit converter with a new unit conversion function based on the new conversion information without updating the unit converter.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary embodiment of a unit conversion system; and

FIG. 2A shows an example of conversion information in a unit conversion system;

FIG. 2B shows another example of conversion information in a unit conversion system;

FIG. 2C shows still another example of conversion information in a unit conversion system;

FIG. 3 is a schematic view showing message exchange between a unit conversion system and another device;

FIG. 4 is a flowchart showing reconfiguration of a unit conversion system;

FIG. 5A shows an example of conversion information updated from data 201 in FIG. 2A;

FIG. 5B shows exemplary conversion information updated from data 202 in FIG. 2B;

FIG. 5C shows exemplary conversion information updated from data 203 in FIG. 2C;

FIG. 6 is a flowchart showing an exemplary operation of a unit converter;

FIG. 7 is a flowchart showing an exemplary unit conversion process with dynamic reconfiguration capabilities; and

FIG. 8 is a schematic view showing hardware configuration of an exemplary embodiment of a device implementing a unit conversion system.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Configurable unit conversion systems and methods thereof are provided in exemplary embodiments organized as:

1. System overview

2. Messaging

3. Configuration of the unit conversion system

4. Unit conversion

5. Hardware configuration

6. Variations

7. Conclusion

### 1. SYSTEM OVERVIEW

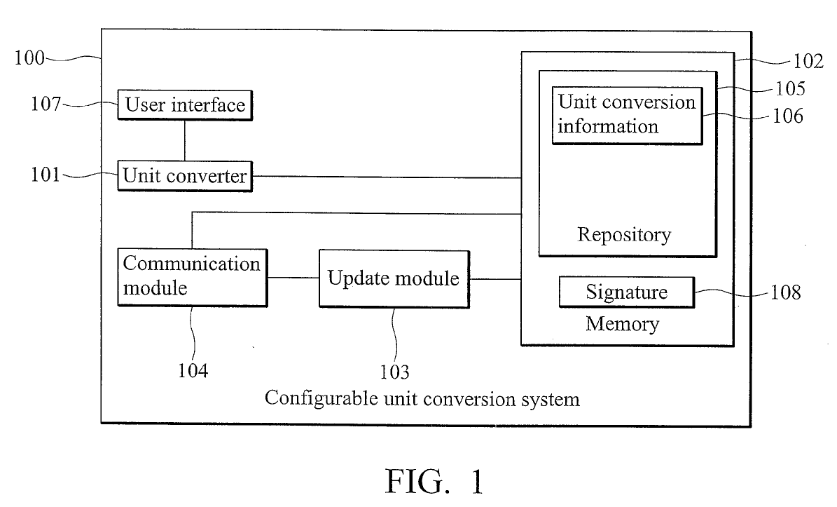

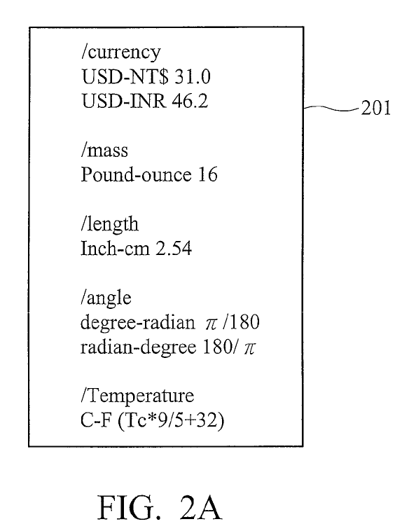

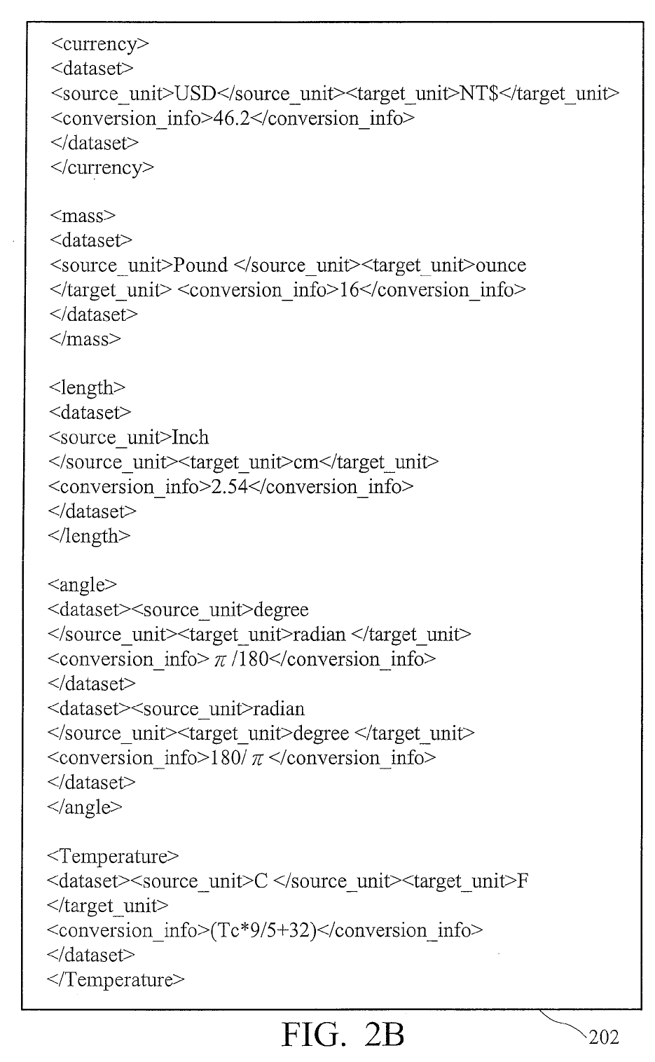

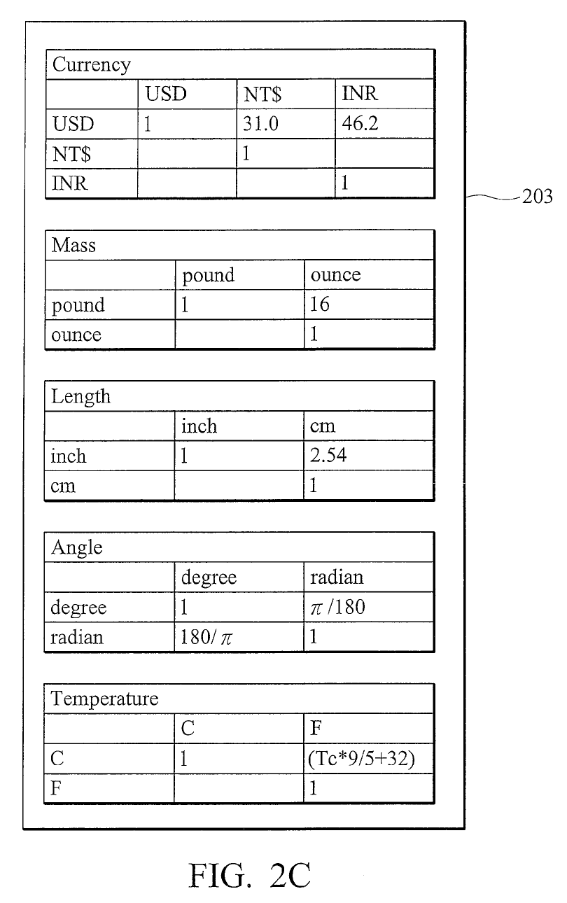

With reference to FIG. 1, configurable unit conversion system 100 comprises unit converter 101, memory 102, update module 103, and communication module 104. Memory 102 comprises a rewritable and nonvolatile memory or storage device, such as a flash memory, a hard disk, or others. Memory 102 comprises a repository 105 of unit conversion information 106. Unit converter 101 utilizes conversion information in repository 105 to convert a value in a unit to a corresponding value in another unit. Repository 105 may comprise a data file, a database, or others. Conversion information 106 comprises a plurality of unit couples, each comprising a source unit and a target unit with a corresponding conversion ratio or formula thereof. Unit converter 101 can utilizes a conversion ratio or formula among conversion information 106 to convert a source unit to a target unit. Conversion information 106 may be organized in forms of text written in markup languages, tables, or any other formats readable by unit converter 101. FIG. 2A˜2C show examples of conversion information 106.

User interface 107 receives a value of a unit to be converted (referred to as a source unit) and another unit to be converted into (referred to as a target unit).

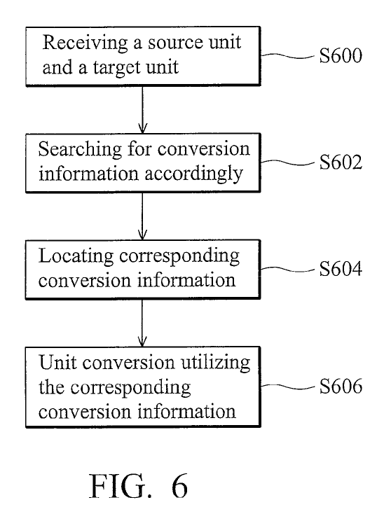

Unit converter 101 performs unit conversion in response to user operations. With reference to FIG. 6, when receiving a source unit and a target unit from user interface 107 (step S600), unit converter 101 accordingly utilizes the source and target units to search repository 105 for corresponding conversion information thereof (step S602). When locating corresponding conversion information of these two units (step S604), unit converter 101 converts a value of the source unit to target unit utilizing the corresponding conversion information (step S606). Unit converter 101 may be implemented by circuits or a computer program executed by a processor.

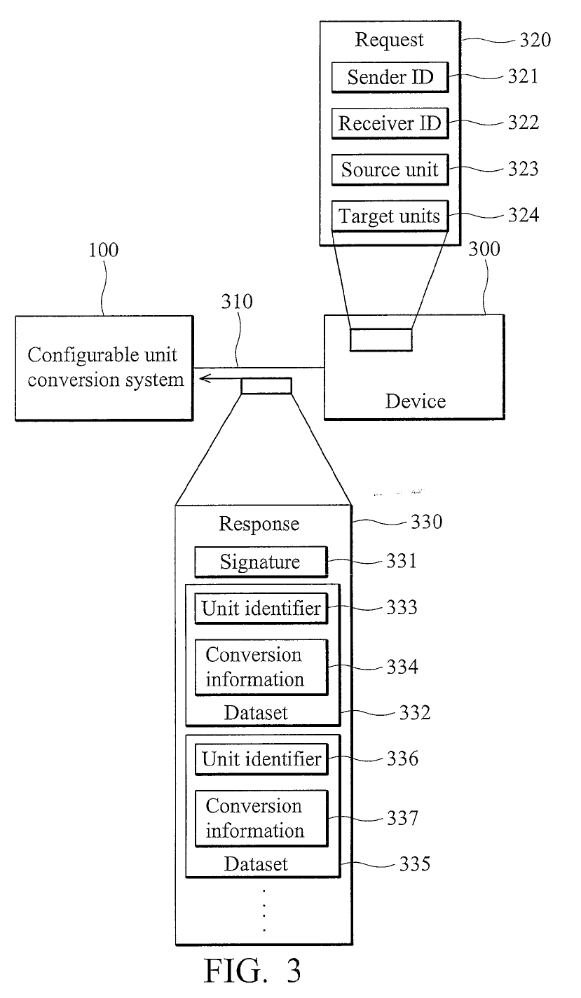

Communication module 104 transmits requests for new conversion information to an external device and receives response messages therefrom. With reference to FIG. 3, unit conversion system 100 couples to device 300 through a channel 310. Channel 310 may be a cabled or wireless connection. Alternatively, unit conversion system 100 may couple to device 300 through a network, such as the Internet, a local area network (LAN), or a telecommunication network. Communication module 104 transmits requests to device 300 and receives a message with new conversion information for updating conversion information 106. The received message may be stored in a nonvolatile memory, such as memory 102, or immediately transferred to and processed by update module 103.

Update module 103 receives the message, extracts new conversion information therefrom, and integrates (or adds) the new conversion information to repository 105 or accordingly updates a set of existing conversion information therein. Unit converter 101 can accordingly utilize the new conversion information for unit conversion. Repository 105 is external to but readable by unit converter 101. Since the new conversion information is retrievable and readable by unit converter 101, no update, amendment, or recreation for unit converter 101 is required. In other words, unit converter 101 can offer new unit conversion functions in runtime without requiring suspension, update, recreation, or restart. The message may comprise a short message service (SMS) message, local messaging services (LMS) message, enhanced messaging services (EMS) message, multimedia messaging services (MMS) message, an e-mail, or a file. Update module 103 may transform unit conversion information in the received message to a predefined format. Update module 103 and communication module 104 may be also implemented by circuits or a computer program executed by a processor.

### 2. MESSAGING

Unit conversion system 100, for example, transmits request 320 for new conversion information to device 300. Request 320 comprises sender ID 321 and receiver ID 322, required source unit 323 and target units 324. Sender ID 321 and receiver ID 322 may respectively comprise phone numbers, e-mail addresses, Internet protocol (IP) address or other identifiers of the sender and the receiver of request 320. Unit conversion system 100 can define the receiver ID as the phone number to which the desired conversion information is to be received for unit conversion. This number may be set as the self number of system 100 to allow self configuration. Device 300 can also be a server of an Internet or telecommunication service provider. Source unit 323 and target unit 324 respectively may be any unit of measure, such as length, speed, angle, mass, temperature, volume, density, time, currency, and others. An exemplary content of request message 320 content may be:

“From: 0977008321;

To: 0925696635;

Kg-Gm;

USD to INR

° F. to ° C.;

Feet-Inch”

After receiving request 320, device 300 transmits response 330 in response. Response 330 comprises signature 331, datasets 332 and 335. Each dataset comprises a unit identifier (such as unit identifier 333 or 336) and corresponding conversion information (such as conversion information 334 or 337) thereof. A response message may possibly include more or fewer datasets. An exemplary content of response message 330 content is given in the following.

Example One:

“Signature: E1D231459;

Kg-Gm 1000;

USD-INR 46.0;

F-C ((T_{f}−32)*5/9);

Feet-Inch 12”.

Signature 331 (such as “Signature: E1D231459”) may be compared to a predefined signature (such as signature 108 in FIG. 1) stored in a nonvolatile memory of unit conversion system 100 for verifying validity of response 330. A unit identifier (such as “Kg-Gm”, “USD-INR”, “F-C”, or “Feet-Inch”) comprise a source unit and a target unit. Conversion information may comprise a unit conversion ratio or formula. For example, ratio “1000” in “Kg-Gm 1000” is a quotient of one kilogram by one gram. In other words, “1000” is the multiplier to translate one kilogram to 1000 gram, or the divisor for translating one gram to 0.001 kg. As well, “46.0” in “USD-INR 46.0” is a quotient of one US dollar by one Indian rupee; “((T_{f}−32)*5/9)” in “F-C ((T_{f}−32)*5/9)” is the formula to translate degrees Fahrenheit to Celsius; and “12” in “Feet-Inch 12” is a quotient of one feet by one Inch.

Device 300 may automatically utilize source unit 323 and target unit 324 as keywords to query a database of unit conversion information and compose response 330 with located conversion information. Note that the device may only locate desired unit information or more related units. For example, when conversion information of Fahrenheit (° F.) to Celsius (° C.) is requested in by request 320, device 300 may reply with Fahrenheit to Celsius, Celsius to Fahrenheit, and Fahrenheit to Kelvin (° K), and Celsius to Kelvin conversion information. When the ratio of a British length unit to a metric length unit is requested by request 320, device 300 may reply with ratios of respective British length units to respective metric length units. Alternatively, device 300 may provide a user interface to receive conversion information and compose response 330 thereby.

The request and response messages may be in various formats, such as tables, extensible markup language (XML) files or similar. Update module 103 can decode response messages, parse message content, extract unit conversion information therefrom, transform the same to a predefined format readable by unit converter 101, and stored the transformed data in a storage area retrievable by unit converter 101.

### 3. CONFIGURATION OF THE UNIT CONVERSION SYSTEM

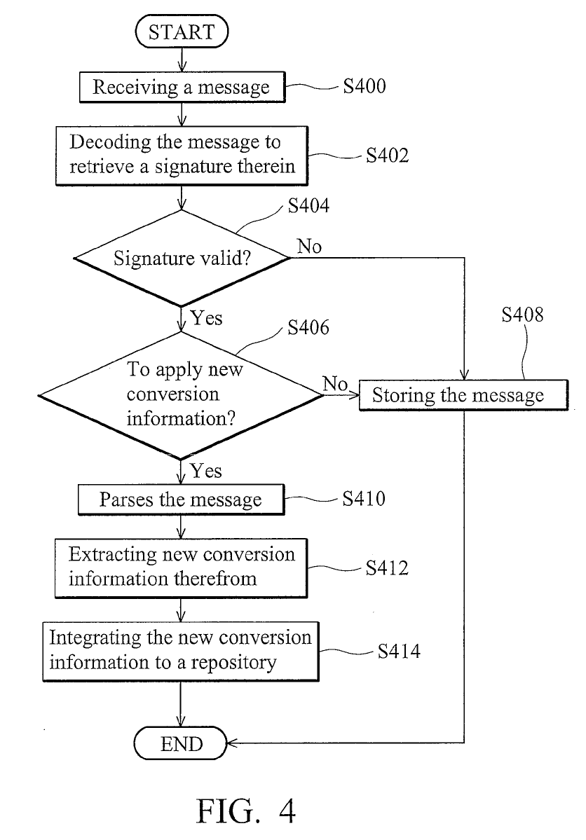

With reference to FIG. 4, communication module 104 receives a message (such as response 330) with new conversion information (such as conversion information 334 and 337) (step S400). Update module 103 decodes the message to retrieve a signature (such as signature 331) therein (step S402) and determines if the signature is valid (step S404). For example, update module 103 may compare signature 331 to a predefined signature (such as signature 108 in FIG. 1) stored in a nonvolatile memory of unit conversion system 100. When matching the predefined signature, the retrieved signature is proven valid, indicating the received message is valid. Otherwise, the retrieved signature is invalid, implying using the received message to update conversion information 106 in repository 105 may pose a risk. Update module 103 may display a warning accordingly.

When the retrieved signature is invalid, update module 103 saves the message in memory 102 (step S408). If necessary, the message may be recalled to apply conversion information therein. When the retrieved signature is valid, update module 103 issues a prompt asking a user to determine whether to apply conversion information in the received message (step S406). If not, update module 103 saves the message in memory 102 (step S408). If so, update module 103 parses the message (step S410) to extract new conversion information therefrom (step S412), and integrates the new conversion information to repository 105 (step S414).

Messages may be stored in an area of memory 102, referred to as an inbox, for future reviewing and re-application of conversion information therein to unit converter 101. That is, conversion information kept in messages in the inbox can be imported to repository 105 to provide unit converter 101 with a new unit conversion function based on the conversion information without updating the unit converter.

Additional security mechanisms may be applied. For example, update module 103 verifies the validity of the message (such as response 330) by identifying a sender ID (such as a phone number) therein, and integrates or adds the new conversion information to repository 105 only when the sender ID is valid. The sender ID is valid if matching the receiver ID (such as receiver ID 322) of the transmitted request (such as request 320).

During update of unit conversion information 106, unit identifiers (such as unit identifier 333 or 336) in the message are used as search key for locating a corresponding record in repository 105. If a record with the same ‘unit identifier’ is located in repository 105, update module 103 then prompts for overwriting confirmation.

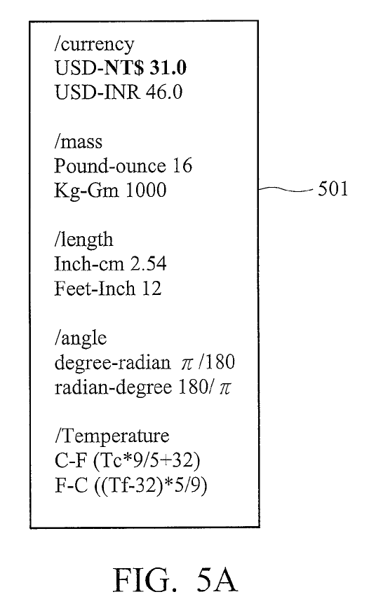

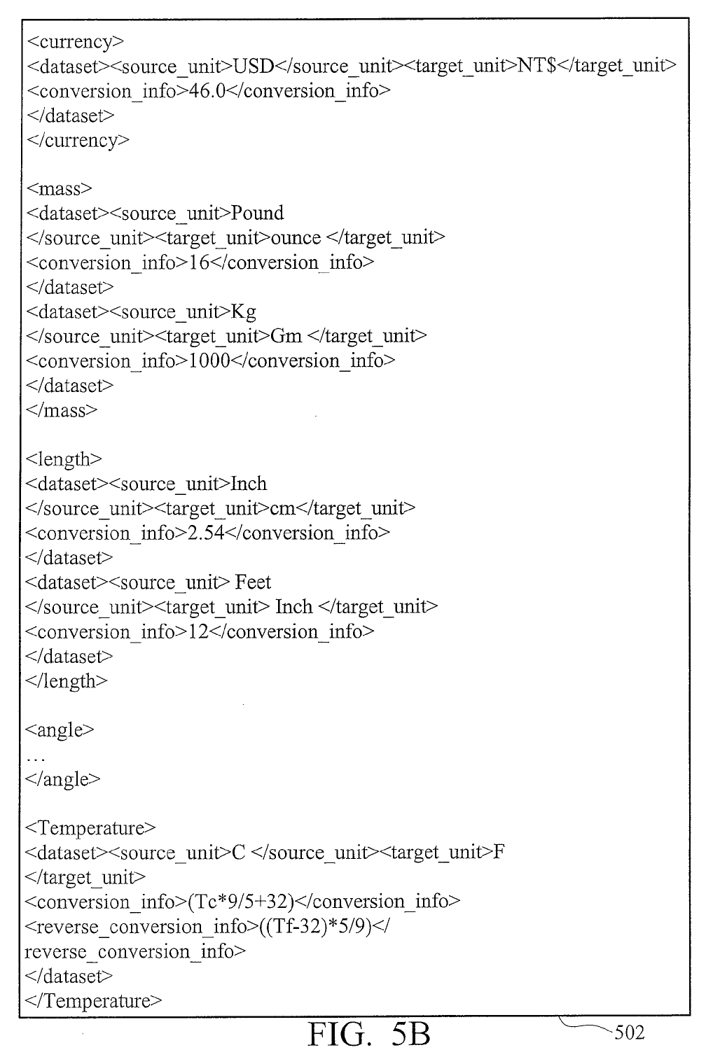

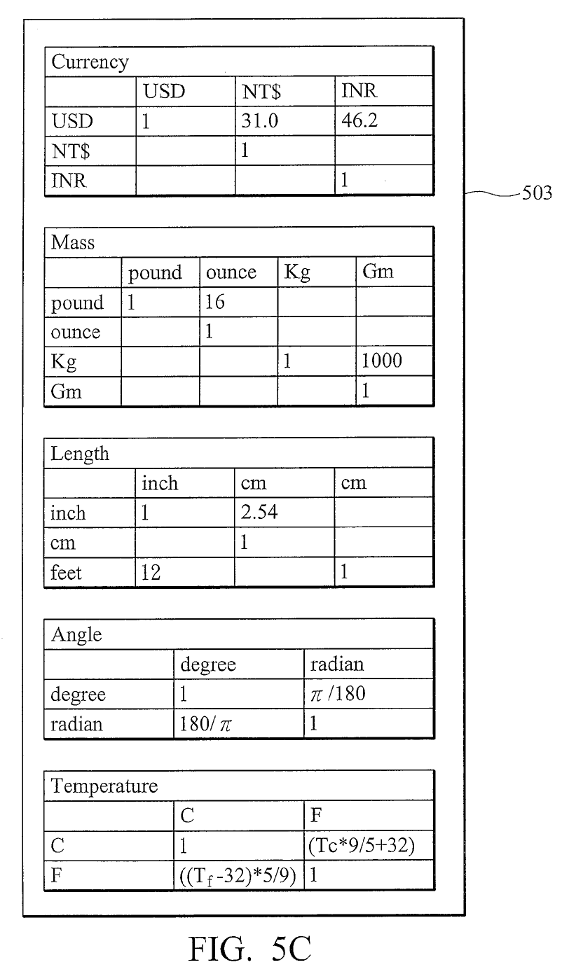

A dataset in the message corresponds to a record in repository 105 if the source and target units in the dataset match those in the record. For each dataset extracted from the message, update module 103 searches unit conversion information 106 for corresponding records. In step S414, when a dataset in the message has a corresponding record in repository 105, update module 103 utilizes the dataset to update the record. Update module 103 integrates or adds a new dataset with no corresponding record to repository 105. For example, when data 201 in FIG. 2A comprises all conversion information 106 in repository 105, and unit conversion system 100 receives a message with content shown in Example one, since datasets “Kg-Gm 1000”, “F-C ((T_{f}−32)*5/9)”, and “Feet-Inch 12” have no corresponding record in data 201, update module 103 integrates or adds these new datasets to repository 105. On the other hand, dataset “USD-INR 46.0” corresponds to record “USD-INR 46.2” in data 201, thus update module 103 update the record with the dataset. FIG. 5A shows the updated conversion information in repository 105. Note that “46.2” in data 201 has been amended to “46.0” in data 501.

When data 202 in FIG. 2B comprise entire conversion information 106 in repository 105, and unit conversion system 100 receives a message with content shown in Example one, update module 103 transforms new datasets in the message to XML format before adding them to repository 105. FIG. 5B shows conversion information updated from data 202 in FIG. 2B. Similarly, when data 203 in FIG. 2C comprise entire conversion information 106 in repository 105, update module 103 transforms new datasets in the message to table format before adding them to repository 105. FIG. 5C shows conversion information updated from data 203 in FIG. 2C.

### 4. UNIT CONVERSION

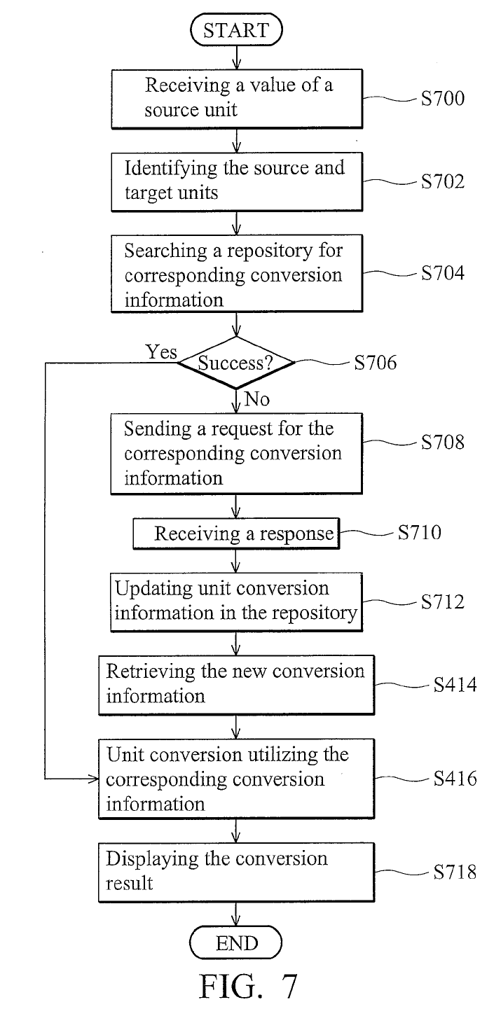

With reference to FIG. 7, unit converter 101 receives a value to be converted from a source unit to a target unit through user interface 107 (step S700) and identifies the source and target units (step S702). For example, unit converter 101 receives 53 feet to be converted to inch. Unit conversion system 100 may respond to the value entry by automatically executing the following steps.

Unit converter 101 utilizes the source and target units to search repository 105 for corresponding conversion information thereof (step S704) and determines if the corresponding conversion information is available in repository 105 (step S706). If so, unit converter 101 converts the value (such as 53 feet) of the source unit to a corresponding value in the target unit (such as inch) utilizing the corresponding conversion information (step S716), and displays the conversion result (step S718). If not, unit converter 101 directs communication module 104 to send a request for the corresponding conversion information (step S708). When receiving a corresponding response, such as response 330 (step S710), update module 103 extract and utilize new conversion information (such as “Feet-Inch 12”) therefrom to update unit conversion information 106 in repository 105 (step S712). Unit converter 101 retrieves (step S714) and utilizes the new conversion information (such as ratio “12” in “Feet-Inch 12”) corresponding to the source and target units to convert the value (such as 53 feet) (step S716) and display the result value of the conversion in the target unit (step S718). For example, unit converter 101 converts 53 feet to 636 inches.

With an update of unit conversion information 106 in repository 105, unit converter 101 may remain unchanged. Information 106 in repository 105 is independent from but retrievable by unit converter 101. Thus, unit converter 101 can offer new unit conversion functions in runtime without requiring suspension, update, re-creation, or restart.

Unit conversion system 100 may be implemented in various electronic devices, an example of which is given in the following.

### 5. HARDWARE CONFIGURATION

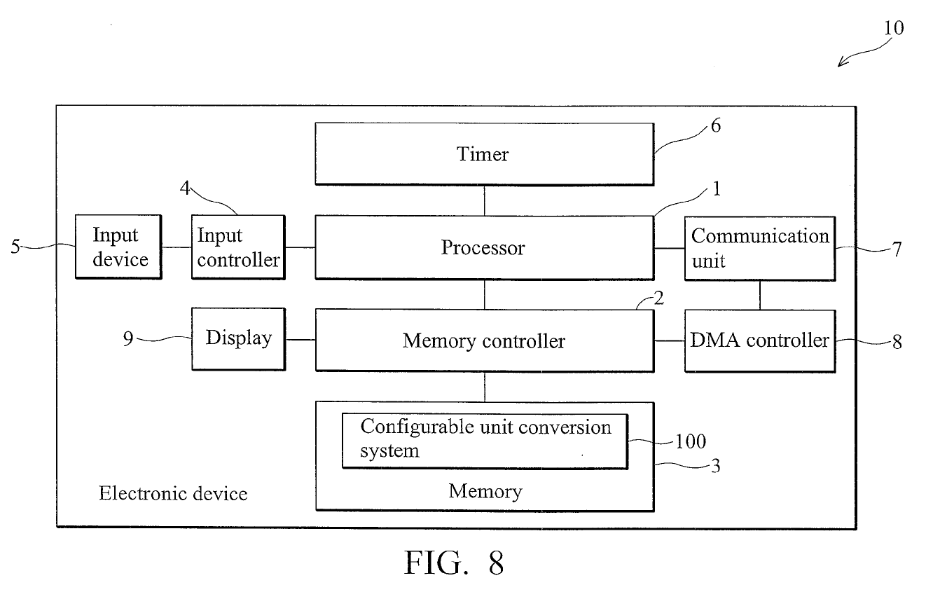

With reference to FIG. 8, electronic device 10 may comprise a mobile phone, a personal digital assistant (PDA), a notebook computer, a tablet personal computer (PC), or any other device capable of data input. Preferably, electronic device 10 comprises an embedded system with limited resources.

In electronic device 10, processor 1 controls operation of the entire system as it fetches and executes software codes stored in memory 3. Memory controller 2 serves as the bridge between processor 1 and memory 3 to transfer data therebetween. Input controller 4 detects states of input device 5 and provides input signals accordingly to processor 1. Input device 5 may comprise a keypad, a touch panel, a touch display, and/or a voice control device by which measurable quantity data may be input. Note that a source unit and a target unit may be selected via any control interface such as voice commands, a mechanical button on the keypad, a virtual button, drop list, or other graphical user interface (GUI) element shown on display 9.

Timer 6 provides timing information to processor 1, so that processor 1 can determine the occurrence time of certain events, such as reception of incoming messages, and duration, the starting or ending time of locating unit conversion information. Timer 6 may comprise a plurality of timing devices, such as a clock reporting current time and a timer triggering events or operations. Display 9 may display user interface 107 in FIG. 1.

Communication module 7 receives and transmits data through a cabled or wireless communication channel. Communication module 7 may comprise infrared, radio frequency (RF), Bluetooth, or other transceiver. Additionally, when unit conversion system 100 is embodied in a mobile phone, communication module 7 can be a cellular MODEM unit, such as a GSM/GPRS or W-CDMA communication module, which communicates with the cellular network in compliance with the Wireless Application Protocol (WAP), GSM/GPRS or W-CDMA standards.

Data outgoing to computer 20 may be prepared and provided by processor 1, or preferably by DMA controller 8 which obtains a data unit from memory 3 through memory controller 2 without intervention of processor 1.

In some embodiments of the electronic device, two components (such as processor 1, memory controller 2, memory 3, or DMA controller 6) may be integrated into a single chip. Some embodiments of the electronic device may comprise only a portion of the elements in FIG. 3 with the others excluded.

### 6. VARIATIONS

Unit conversion system 100 may also provide options for deleting the existing conversion information. This helps control the number of unit conversion functions available on unit conversion system 100. Unit conversion system 100 may also provide options to re-apply the existing unit conversion information again from an inbox storing messages.

Signature identification may be disabled or excluded in some embodiments of the configurable unit conversion system. Message parsing may start immediately upon message reception or display. The signature identification time may be modified to any time after message reception, before message display or data repository update. Unit conversion information with no valid signature may be applied if authorized by a system user.

Receiving unit conversion logic as plug-ins to unit converter 10 is possible. A unit conversion logic comprises not only unit conversion information but also codes for implementing unit conversion formulas or enhancing user interface 107.

### 7. CONCLUSION

Because messages can be received to import new unit conversion information to a data repository of unit conversion system 100, the unit converter is highly adaptable to local needs. Since all countries have local currencies, length and mass units, the system may be dynamically configured to support unit conversion therebetween by message exchange and data update. Unit conversion system 100 can send messages to itself or get unit conversion information from external devices with desired unit conversion information. Additionally, because the communication may be based on standard messaging, most devices can support the communication.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A configurable unit conversion system, comprising:
a memory comprising a repository of unit conversion information;
a unit converter converting a first unit to a second unit utilizing unit conversion information in the repository;
a communication module receiving a message transferred to the system; and
an update module extracting new conversion information from the received message and integrating the new conversion information to the repository to enable automatic utilization by the unit converter of the new conversion information for unit conversion.

2. The system as claimed in claim 1, wherein the update module generates new conversion information by parsing the message.

3. The system as claimed in claim 1, wherein the message comprises a ratio of the first unit to the second unit.

4. The system as claimed in claim 1, wherein the message comprises a formula for converting the first unit to the second unit.

5. The system as claimed in claim 1, wherein the update module verifies the validity of the message before integrating the new conversion information to the repository.

6. The system as claimed in claim 5, wherein the update module verifies the validity of the message by identifying a signature therein, and integrates the new conversion information to the repository only when the signature is valid.

7. The system as claimed in claim 6, wherein the signature is valid if matching a predetermined signature stored in the system.

8. The system as claimed in claim 5, wherein the update module verifies the validity of the message by identifying a sender ID therein, and integrates the new conversion information to the repository only when the sender ID is valid.

9. The system as claimed in claim 8, wherein the communication module transmits a request for the new conversion information, and the sender ID is valid if matching the destination where the request is transmitted.

10. The system as claimed in claim 1, wherein the message comprises a short message service (SMS) message, local messaging services (LMS) message, enhanced messaging services (EMS) message, multimedia messaging services (MMS) message, an e-mail, or a file.

11. The system as claimed in claim 1, wherein the new conversion information in the message is arranged in a table or text format.

12. The system as claimed in claim 1, wherein the system comprises a mobile phone or a personal digital assistant (PDA).

13. A unit conversion system configuration method, wherein the unit conversion system comprises a unit converter converting a first unit to a second unit utilizing a repository of unit conversion information in the system, comprising:
receiving a message transferred to the system;
extracting new conversion information from the received message; and
integrating the new conversion information to the repository to enable automatic utilization by the unit converter of the new conversion information for unit conversion.

14. The method as claimed in claim 13, further comprising generating new conversion information by parsing the message.

15. The method as claimed in claim 13, wherein the message comprises a ratio of the first unit to the second unit or a formula for converting the first unit to the second unit.

16. The method as claimed in claim 13, further comprising verifying the validity of the message before integrating the new conversion information to the repository.

17. The method as claimed in claim 16, further comprising verifying the validity of the message by identifying a signature therein, wherein the integration of the new conversion information to the repository is performed only when the signature is valid.

18. The method as claimed in claim 17, wherein the signature is valid if matching a predetermined signature stored in the system.

19. The method as claimed in claim 16, further comprising verifying the validity of the message by identifying a sender ID therein, and the integration of the new conversion information to the repository is performed only when the sender ID is valid.

20. The method as claimed in claim 19, wherein the sender ID is valid if matching the destination to which a request is transmitted by the system.

21. The method as claimed in claim 13, wherein the message comprises a short message service (SMS) message, local messaging services (LMS) message, enhanced messaging services (EMS) message, multimedia messaging services (MMS) message, an e-mail, or a file.

22. The method as claimed in claim 13, wherein the new conversion information in the message is arranged in a table or text format.

23. A unit conversion system configuration method, wherein the unit conversion system comprises a unit converter converting a unit to another unit, comprising:
receiving a value of a source unit to be converted to a target unit;
utilizing the source unit and the target unit to search for corresponding conversion information in the system; and
when the corresponding conversion information is unavailable in the system, automatically sending a request for the corresponding conversion information of the source unit and the target unit.

24. The method as claimed in claim 23, further comprising:
receiving a response with the requested corresponding conversion information;
integrating the corresponding conversion information to the system; and
execution of unit conversion by the unit converter utilizing the corresponding conversion information.
